(19) United States
(12) Patent Application Publication
(10) Pub. No.: US 2013/0120404 A1
(43) Pub. Date: May 16, 2013

(54) Animation Keyframing Using Physics

(71) Applicants: Eric J. Mueller, Fremont, CA (US); Anthony C. Mowatt, Emeryville, CA (US); John C. Mayhew, San Francisco, CA (US)

(72) Inventors: Eric J. Mueller, Fremont, CA (US); Anthony C. Mowatt, Emeryville, CA (US); John C. Mayhew, San Francisco, CA (US)

(21) Appl. No.: 12/713,059

(22) Filed: Feb. 25, 2010

(51) Int. Cl. G06T 13/00; G06F 3/048

(52) U.S. Cl. 345/474; 715/723

(57) ABSTRACT

An animation-authoring environment includes a graphical user interface usable by a user to define an initial key frame, including one or more scene entities with one or more respective physics properties. The authoring environment generates a sequence of extrapolated frames from the initial key frame by using a physics simulation to extrapolate respective motion paths for scene entities in the key frame and configuring each frame in the generated sequence to depict each such scene entity at a successive location along its respective extrapolated motion path. The authoring environment may then produce a movie comprising the sequence of frames.

### BACKGROUND

In traditional film or computer animation, a movie may be composed of an ordered set of still scenes known as frames. When the frames are displayed to an audience in quick succession, various entities on the frames may appear to be animated.

To avoid the tedious task of drawing each frame manually, computer animation authoring environments, such as Adobe Flash CS4 Professional, allow a user to create a subset of the animation frames in the movie sequence (key frames) and allow the computer to generate the remaining frames by interpolating the location of various entities for frames in between the key frames. The interpolated frames are known as in-between frames or tween frames and the process of generating them is known as tweening.

For example, using an animation environment such as Adobe Flash Professional, an author can specify the starting and ending position of a given object in a scene using two key frames and then allow the authoring environment to interpolate a series of tween frames between the two key frames such that when all the frames are animated together, the object appears to move in a continuous path from its position in the first key frame to its position in the second key frame.

To achieve a desired effect, an author may then use the authoring environment to apply modifications to various ones of the key frames and/or tween frames, to convert some tween frames to key frames, to regenerate tween frames, and/or to apply various other changes to the animation. In many circumstances, creating the appearance of realistic motion using such key framing techniques may be tedious and/or may require specialized artistic skills.

### SUMMARY

In various embodiments, an animation-authoring environment may include a graphical user interface usable by an animation author to define an initial key frame, including one or more scene entities. The author may assign respective physics properties various to ones of the scene entities, such as properties of matter (e.g., mass, volume, density, elasticity, friction, etc.), initial conditions (e.g., linear velocity, angular velocity, etc.), and/or forces acting upon the scene entity (e.g., gravity, resistance, other acceleration, etc.).

The authoring environment may extrapolate a sequence of frames from the initial key frame by using a physics simulation to extrapolate respective motion paths each scene entity with assigned physics properties, based at least on their initial positions and physics properties. Using the extrapolated paths, the authoring environment may generate the sequence of frames such that each scene entity is depicted at a successive location along its respective extrapolated motion path. The author may then use the authoring environment to generate a movie that includes the sequence of frames.

In some embodiments, a given extrapolated motion path may be dependent on one or more others of the extrapolated motion paths. For example, if the motion paths of two scene entities intersect, the two scene entities may deflect off of one another. In some embodiments, various ones of the motion paths may be independent of others, even if they intersect. In some instances, the initial key frame and/or other frames in the sequence may also include scene entities not assigned physics properties and for whom a motion path is not extrapolated.

In some embodiments, a user may modify various scene entities in the generated frame sequence. In some embodiments, an author may designate various ones of the generated frames as key frames and define motion paths for various scene entities without physics properties, such as by using traditional interpolative techniques.

### BRIEF DESCRIPTION OF THE DRAWINGS

FIG. 1 illustrates an example of an animation-authoring environment usable to generate a movie that includes a sequence of frames extrapolated from an initial key frame using a physics-based simulation engine, according to some embodiments.

FIG. 2 illustrates an example of two extrapolated motion paths being affected by one another, according to some embodiments.

FIG. 3 is a flow diagram illustrating a method for creating a movie using physics-based extrapolation as described herein, according to some embodiments.

FIG. 4 is a block diagram illustrating the various components of an animation-authoring environment configured to extrapolate motion paths for scene entities, according to some embodiments.

FIG. 5 is a block diagram illustrating an example computer system configured to implement an animation-authoring environment implementing physics-based frame extrapolation, as described herein.

While the invention is described herein by way of example for several embodiments and illustrative drawings, those skilled in the art will recognize that the invention is not limited to the embodiments or drawings described. It should be understood that the drawings and detailed description hereto are not intended to limit the invention to the particular form disclosed, but on the contrary, the invention is to cover all modifications, equivalents and alternatives falling within the spirit and scope of the present invention as defined by the appended claims. Any headings used herein are for organizational purposes only and are not meant to limit the scope of the description or the claims. As used herein, the word “may” is used in a permissive sense (i.e., meaning having the potential to) rather than the mandatory sense (i.e. meaning must). Similarly, the words “include”, “including”, and “includes” mean including, but not limited to.

### DETAILED DESCRIPTION OF EMBODIMENTS

In traditional computer animation (e.g., Flash animation), authors can use an animation-authoring environment (e.g., Adobe Flash Professional) to create a movie by manually placing scene entities on two different key frames and then having an interpolation engine, which may be integrated into the authoring environment, generate a sequence of “tween” frames that are in-between the two key frames. The interpolation engine determines the position of each scene entity in each tween frame based on the start and end locations of the scene entity in the two key frames and on the position of the tween frame in the resulting frame sequence. An author may create a movie by creating any numbers of key frames and using the interpolation engine to create tween frames between each pair. Unfortunately, creating the appearance of realistic motion using such interpolation-based techniques may be tedious and/or may require specialized artistic skills.

According to various embodiments, an animation-authoring environment may allow an author to create the appearance of realistic motion by extrapolating frames rather than by only interpolating them. For example, in some embodiments, an author may use an animation-authoring tool to specify a scene entity (or multiple entities) on an initial key frame and to assign the scene entity one or more physics properties, such as a vector velocity, angular velocity, acceleration, gravitational pull, elasticity, mass, force, friction, and/or other physics properties. The author may then use an extrapolation engine of the authoring environment to generate a sequence of subsequent frames based on the initial key frame and the physics properties assigned to the screen entity. In some embodiments, the authoring environment may utilize a physics simulator to calculate an extrapolated motion path of the entity.

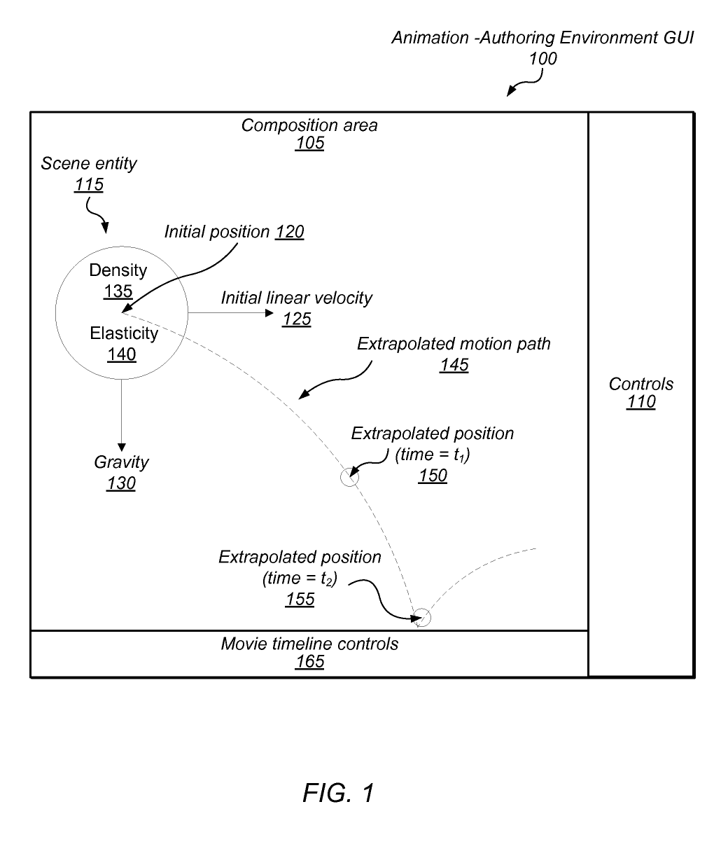

FIG. 1 illustrates an example of an animation-authoring environment usable to generate a movie that includes a sequence of frames extrapolated from an initial key frame using a physics-based simulation engine, according to some embodiments.

According to the illustrated embodiment, animation-authoring environment GUI 100 includes composition area 105, controls 110, and movie timeline controls 165. In various embodiments, the animation-authoring GUI may include fewer and/or additional other controls, such as a tool bar, menu bar, floating palette(s), and/or other GUI components. In some embodiments, various functions of the environment may be invoked using a mouse and/or using various keyboard shortcuts.

In the example of FIG. 1, an author may use composition area 105 for drawing, viewing, and otherwise manipulating scene entities in various frames, such as in an initial key frame. As used herein, the term scene entity refers to any entity depicted as part of a scene on any frame of an animation.

In one example, to draw scene object 115, the user may use controls 110 (and/or other controls) to indicate that he wishes to draw a circle and then use a mouse input device to draw the circle (scene entity 115) at initial position 120 in composition area 105. In some embodiments, a user may draw the circle by clicking the mouse on an initial location (e.g., 120) and dragging the mouse to indicate a desired radius of the circle. Those skilled in the art will realize that scene objects may be defined using various other controls and inputs of a graphical user interface, such as animation-authoring environment GUI 100.

In some embodiments, defining scene entity 115 may further include specifying various physics properties of the scene entity. For example, a user may draw scene entity 115 and subsequently use various GUI controls (e.g., controls 110) to specify physics properties of scene entity 115, such as linear velocity 125, gravity 130, density 135, elasticity 140, size, and/or other properties that enable the authoring environment to generate subsequent frames using a physics-based extrapolation technique. In various embodiments, physics properties of a scene entity may include any properties of matter (e.g., mass, volume, density, elasticity, friction, etc.), initial conditions (e.g., linear velocity, angular velocity, etc.), and/or forces acting upon the scene entity (e.g., gravity, resistance, other acceleration, etc.) that may enable a full or partial physics simulator to extrapolate a motion path for the scene entity from an initial key frame.

For example, in the illustrated example of FIG. 1, a user has assigned at least one initial condition (linear velocity 125) to scene entity 115. In some embodiments, a user may define such an initial velocity according to a Euclidian vector. In different embodiments, a Euclidian vector may be specified using direction and magnitude values, Δx and Δy values, and/or other parameterizations.

In some embodiments, other initial conditions (e.g., angular velocity) and/or forces acting on the scene entity (e.g., gravity) may also be defined according to Euclidian vectors. For example, in the illustrated embodiment, the author has defined gravity for scene entity 115 as gravity vector 130. Some properties, such as gravity, may be defined as global physics properties and consequently applied to a plurality of scene entities. In the illustrated example, the user has also assigned at least two properties of matter to scene entity 115, including density 135 and elasticity 140.

According to some embodiments, after defining an initial key frame with one or more scene entities having one or more physics properties (e.g., scene entity 115 with physics properties 125-140), an animation author may request that the environment extrapolate a sequence of frames from the given initial frame (including scene entities and their physics properties).

In various embodiments, the author may control the number of frames generated for the sequence by adjusting various parameters. For example, a user may specify a frame rate (e.g., 10 frames per second) and a period of time for which the extrapolation should extend. In this case, the number of frames in the sequence would be the product of the frame rate and specified period of time. In an alternate example, the user may specify a frame rate and a number of frames to generate. In various embodiments, the user may use controls 110, 165, and/or other controls to specify such parameters.

After specifying an initial key frame with one or more scene entities and a number of frames to generate (e.g., frame rate, time period, frame number, etc.), the user may request that the authoring environment generate the sequence of frames. According to some embodiments, the authoring environment may utilize a physics simulator to extrapolate a motion path (e.g., extrapolated motion path 145) for each scene entity, according to that entity's physics properties and/or the global properties of the scene.

Each position along an extrapolated motion path corresponds to a given time, starting from the initial key frame and going forward. For example, according to extrapolated motion path 145, scene entity 115 is at initial position 120 at time t₀, extrapolated position 150 at time t₁, and extrapolated position 155 at time t₂.

In various embodiments, the extrapolated path may be dependent on interaction with one or more other scene entities. For example, at extrapolated position 155, scene entity 115 collides with a floor entity and consequently bounces. The physics simulation engine may utilize various physics properties of scene entity 115 at that position (e.g., velocity vector, density 135, elasticity 140, etc.) to calculate a reflection vector of the bounce. For example, the physics simulation may use density 135 and size of scene entity 115 to calculate a mass for the scene entity, and gravity 130 and initial linear velocity 125 to calculate a velocity vector at time t₂. The physics engine may calculate the resulting vector for the bounce using elasticity 140 and the calculated mass and velocity at t₂.

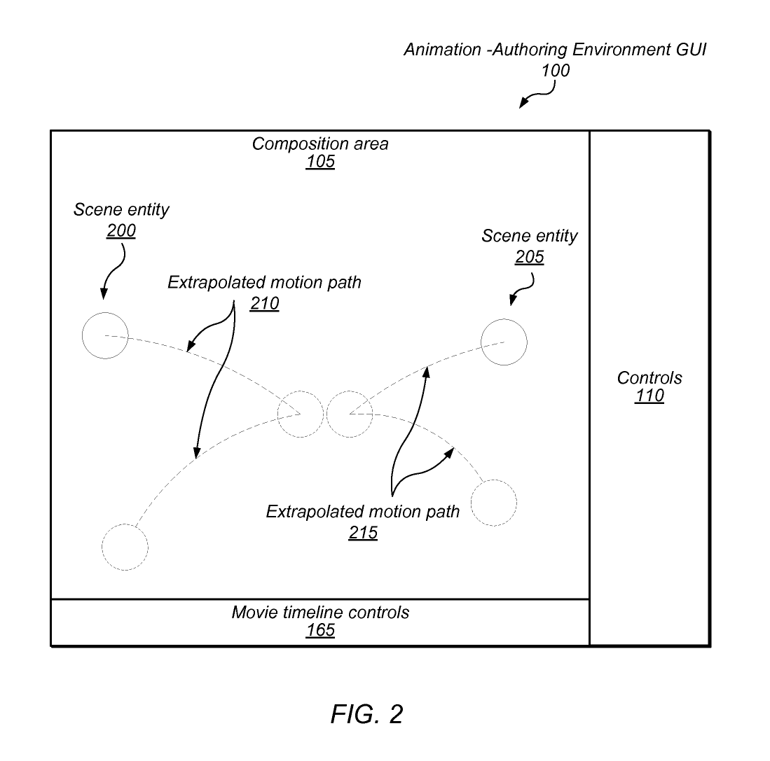

In some situations, an extrapolated motion path of one scene entity may affect that of another scene entity. FIG. 2 illustrates an example of two extrapolated motion paths being affected by one another, according to some embodiments. In the illustrated example, the author has drawn two scene entities (200 and 205) and has assigned each entity respective physics properties (not shown). As illustrated, the physics engine calculates extrapolated motion path 210 for scene entity 200 and extrapolated motion path 215 for scene entity 205. These two motion paths collide and so the physics engine calculates a ricochet for this collision. Thus, extrapolated motion path 210 is affected by extrapolated motion path 215 and vice versa.

An extrapolated motion path, such as 145, therefore corresponds to a function that defines a position of a given scene entity (e.g., scene entity 115) in a scene for any time tₙ between t₀ and t_{final}, where t₀ corresponds to the initial time and t_{final} corresponds to the latest time in the animation, as specified by the author. For example, in FIG. 1, extrapolated motion path 145 maps the location of scene entity 115 to extrapolated position 150 at time t₁ and extrapolated position 155 at time t₂.

In some embodiments, the authoring environment may generate the frame sequence by sampling the location(s) of each scene object along its respective extrapolated motion path at intervals corresponding to the frame rate. For example, if the author of FIG. 1 indicates that the animation frame rate is 10 frames per second for 10 seconds, then the authoring environment may generate 100 frames. Thus, the nth frame of the 100 frames may correspond to time t₀+(0.1*n)sec of the animation and therefore depict scene entity 115 at a position of extrapolated motion path 145 corresponding to that time.

In some embodiments, after the authoring environment has generated the sequence of frames based on the extrapolated path(s) of the depicted scene entity or entities and the frame rate and duration information supplied by the author, the environment may allow the user to view and/or modify any of the sequence of frames. For example, movie timeline controls 165 may include a play feature that animates the movie by displaying each frame in the sequence in succession. In some embodiments, movie timeline controls may include a scrubber that allows the author to move forward or backwards through the movie to view different frames corresponding to respective times. In some embodiments, movie timeline controls 165 may also include an indication of a time of the animation to which a given displayed frame corresponds.

In some embodiments, the authoring environment may allow the author to manually edit one or more of the sequence of frames in the animation. For example, the author may decide to color scene entity 115 a given color in all or just some of the frames. The author may also move the scene entity to a different location in any frame, add more scene entities, and/or make arbitrary other adjustments.

In some embodiments, the authoring environment may support both physics-based extrapolation and traditional interpolation techniques. For example, if the author wishes for scene entity 115 to gradually change from yellow to red as it travels along motion path 145, he may designate the first and last frames of the animation as interpolation key frames with entity 115 being yellow in the first frame and red in the last. The authoring environment may then automatically assign an appropriate color along the yellow-red spectrum to entity 115 in each frame in the sequence such that the transition from yellow to red appears gradual.

In another embodiment, the author may add new scene entities that are not physics based, to various frames in the sequence. For example, the author may add a second entity to the initial key frame of FIG. 1 and designate that the second entity not move along an extrapolated path (as does entity 115), but rather along an interpolated path. In this example, the author may choose another frame in the sequence (e.g., the last frame), designate that frame as another key frame of the animation, and draw the second entity in a final target position in that other key frame. In response, the authoring environment may modify each of the frames between the two key frames to draw the second object at an interpolated position as is traditionally done. Thus, the frame sequence may concurrently depict both a first object (entity 115) whose path was determined using physics-based extrapolation and a second object whose path was determined using traditional interpolation.

In some embodiments, the author may designate various scene entities to have extrapolated paths and various other entities to have interpolated paths. The author may also designate whether or not the extrapolated paths should be dependent on the interpolated paths. For example, if the extrapolated path is not dependent on interpolated paths, then an entity traveling along an extrapolated path may cross an object traveling along an interpolated path with out bouncing, reflecting, or otherwise reacting to the intersection event. In contrast, if the extrapolated path is dependent on interpolated paths, then an object traveling along an extrapolated path may bounce, reflect, or otherwise react to crossing paths with an object traveling along an interpolated path.

Once the author is satisfied with the animation, he may request that the authoring environment output the sequence of frames as a movie. The specific output format may depend on the environment and/or may be configurable. For example, if the author is creating a Flash movie, then the movie may be output in a .fla format. In some embodiments, the authoring environment may allow the author to automatically compile the Flash movie into an executable .swf movie file. Various other movie output formats are possible, such as Windows Media (.wmv), audio video interleave (.avi), or others.

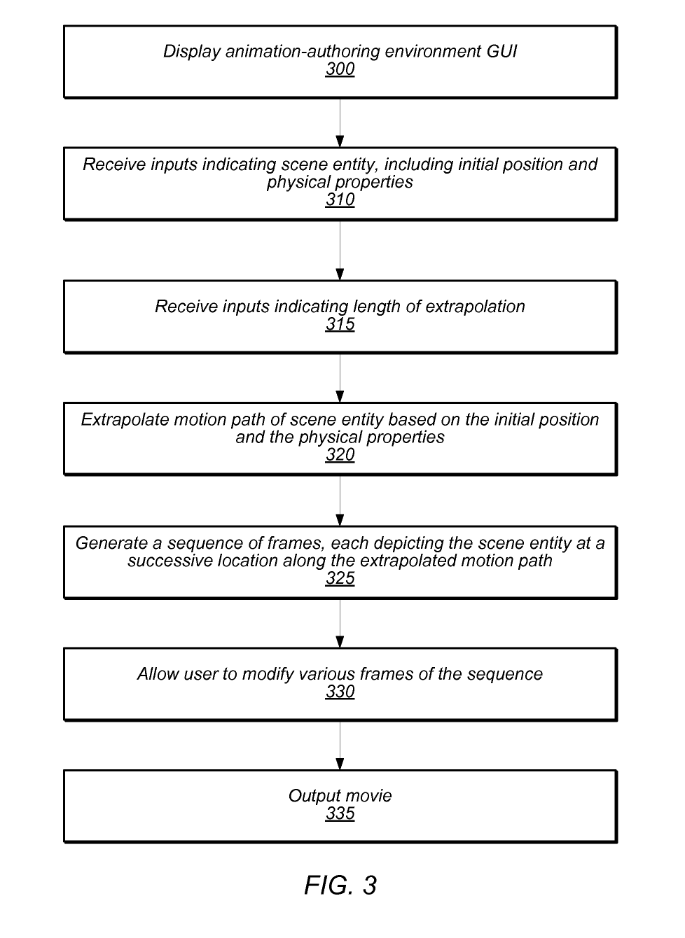

FIG. 3 is a flow diagram illustrating a method for creating a movie using physics-based extrapolation as described herein, according to some embodiments. The method may be performed by an animation-authoring environment being used by an animation author.

According to the illustrated embodiment, the authoring environment may display an animation-authoring environment GUI, as in 300. For example, the GUI may correspond to animation-authoring environment GUI 100 in FIGS. 1 and 2. The GUI may include a composition area for drawing an initial key frame (e.g., composition are 105) and/or various controls to assist in composing and/or controlling the movie output.

The method of FIG. 3 then includes receiving various inputs indicating one or more scene entities, including initial positions and physics properties for each scene entity, as in 310. As described above, various scene entities may be drawn in a composition area and assigned physics properties, such as properties of mass, initial conditions, and/or global forces. Some physics properties (e.g., gravity) may be applied globally to multiple scene entities.

In some embodiments, the author may draw various other entities and whose motion is not determined by extrapolation techniques described herein. For example, some such scene entities may be stationary while others may move along a path determined by interpolation techniques invoked by the author. As described above, various ones of these scene entities may or may not affect the extrapolated paths of various physics-based objects.

The method then includes receiving inputs from the user indicating the length of the extrapolation, as in 315. In various embodiments, such information may include a frame rate and a number of frames or extrapolation time. Thus, the authoring environment may determine the length in time of the necessary extrapolations for the physics-based scene entities, such that it may generate the proper number of frames at the given frame rate.

According to the illustrated embodiment, the authoring environment may then extrapolate a motion path of each scene entity based at least on its initial position and physics properties, as in 320. As described above, each extrapolated motion path may be determined using a physics simulation with the initial position and physics properties as in input. In some instances, a given extrapolated motion path may be dependent on the motion paths and/or physics properties of one or more other entities. For example, when an extrapolated motion path of a first scene entity intersects that of another scene entity, the physics simulator may detect the collision and calculate a ricochet effect, which may be dependent on various physics properties of the colliding entities, such as the mass, velocity vectors, angular velocity, elasticity, and/or other physics properties of each entity.

As shown in FIG. 3, the authoring environment may then generate a sequence of frames, each corresponding to a given time in the animation, as in 325. As illustrated in 325, for a given object moving along an extrapolated motion path, each frame may depict the object at a position along its motion path corresponding to the time associated with that frame. For example, if the authoring environment is configured to generate 10 frames per second, then the 10^{th} frame may depict each scene entity at a position along its respective motion path corresponding to time t₀+1 s.

In various embodiments, extrapolating the motion paths in 320 and generating the sequence of frames in 325 may be performed sequentially (as illustrated) or together in parallel. For example, in some embodiments, the authoring environment may create the sequence of frames by iteratively advancing the physics simulation to the next point in time corresponding to the next frame and generating that frame before advancing the simulation to the next point in time, and so forth.

As in 330, the authoring environment may then allow the user to modify any of the various frames in the movie sequence. In various embodiments, such modification may include altering the location, color, shape, appearance, physics properties, and/or any other properties of one or more scene entities, adding or removing scene entities, modifying global physics properties, designating additional key frames for interpolation-based motion techniques, or any other modifications to one or more frames. In some embodiments, if a user alters the physics properties of a given scene entity in a frame, adds a scene entity to a frame, or removes a scene entity from a frame, the authoring environment may regenerate subsequent frames, such as by recalculating various extrapolated motion paths using the modified frame as an initial key frame.

As in 335, the authoring environment may then output a movie comprising the generated frame sequence. For example, if the authoring environment is one for authoring a Flash movie (e.g., Adobe Flash Professional), the output format may be a .fla file or a compiled .swf file. In the latter case, the authoring environment may include and/or invoke a Flash compiler to produce the .swf file. In some embodiments, the authoring environment may include and/or invoke various movie file conversion applications to output movies in various formats (e.g., .mov, .avi, .wmv, etc.).

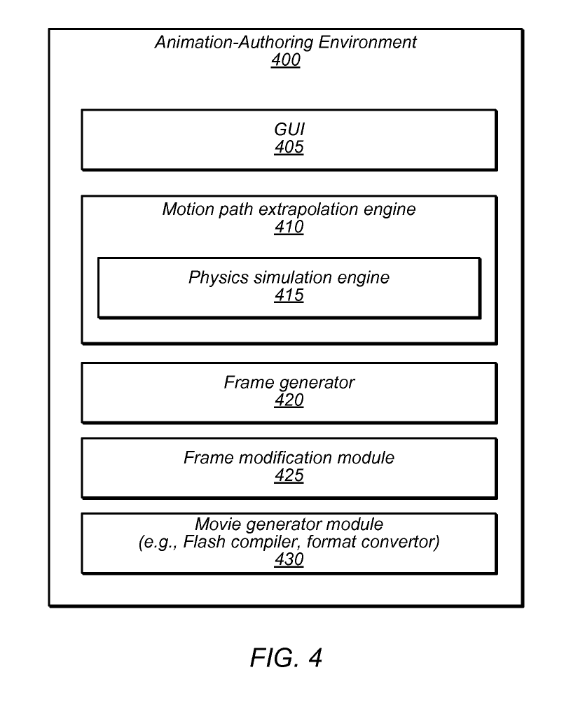

FIG. 4 is a block diagram illustrating the various components of an animation-authoring environment configured to extrapolate motion paths for scene entities, according to some embodiments. In some embodiments, the authoring environment may correspond to a Flash authoring environment, such as Adobe Flash Professional.

According to the illustrated embodiment, animation-authoring environment 400 includes graphical user interface (GUI) 405. GUI 405 may be displayed visually on one or more screens and enable an animation author to interact with the environment, such as through clicks and motions of a mouse pointing device and/or through keystrokes of a keyboard device. For example, GUI 405 may include a composition area (e.g., 105) where the author may draw components using a mouse pointing device and various controls areas (e.g., 110, 165) where the author may define various parameters, such as physics parameters for each object and/or global physics parameters.

As shown in the illustrated embodiment, animation-authoring environment 400 may also include a motion path extrapolation engine (such as 410) to extrapolate motion paths for one or more scene entities in an initial key frame. In some embodiments, the extrapolated paths may be calculated dependent on a physics simulation engine, such as 415. In such embodiments, the physics simulation engine 415 may extrapolate a motion path of a given scene entity based on any number of physics properties assigned to that entity. For example, a physics simulation engine may determine a velocity vector for a give scene entity at various time frames based on an initial velocity vector of the entity and a global gravity parameter. In some cases, the physics simulation engine may also calculate the effects of collisions of multiple scene entities, such as based on respective velocity vectors, masses, and/or elasticity values of the entities involved.

According to the illustrated embodiment, animation-authoring environment 400 may also include frame generator 420. Frame generator 420 may be configured to generate a chronologically-ordered sequence of frames depicting various scene entities from an initial key frame at positions along their respective extrapolated motion paths. As described above, the frame generator may also configure one or more frames to include various scene entities moving along an interpolated path.

Animation-authoring environment 400 also includes a frame modification module 425 that may enable an author to modify various frames generated by frame generator 420, as discussed above. For example, frame modification module 425 may allow a user to create and/or remove scene entities in an initial key frame and/or in a frame generated by frame generator 420. In some embodiments, modification module may allow an author to add and/or modify physics properties of various scene entities in any frame or to modify the appearance of such entities (e.g., color).

According to the illustrated embodiment, animation-authoring environment may further include a movie generator module 430 configured to output a movie file comprising the generated frame sequence. In various embodiments, movie generator module 430 may include different components depending on the input and/or output format. For example, if authoring environment 400 is configured to create Flash movies, then movie generator module 430 may be configured to output a Flash source code file (.fla). In further embodiments, such an authoring environment may also include a Flash compiler, which may compile the Flash source file into an executable file format (e.g., .swf file). In alternate embodiments, the movie generator may be configured to generate a movie in a different format. In some embodiments, the movie generator module may include various file format converters configured to convert movie files from a first format to another. In such embodiments, the author may select different movie formats for the authoring environment to output.

In various other embodiments, animation-authoring environment may include additional or fewer components. For example, the functionality of various components may be combined into a single component and/or the functionality of a given component may be broken out into multiple components.

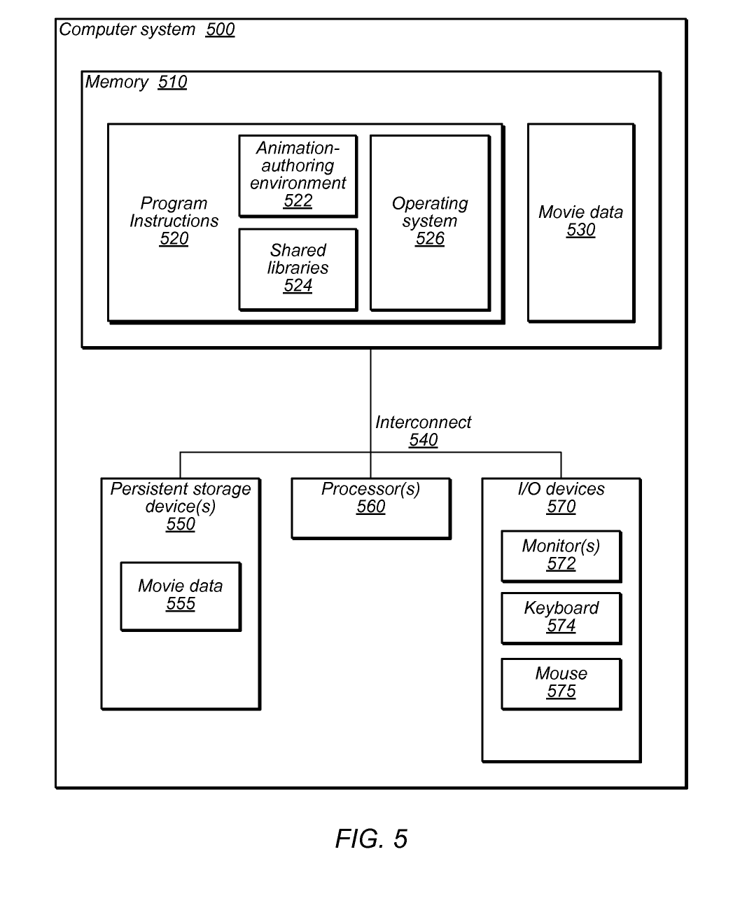

FIG. 5 is a block diagram illustrating an example computer system configured to implement an animation-authoring environment implementing physics-based frame extrapolation, as described herein. The computer system 500 may be any of various types of devices, including, but not limited to, a personal computer system, desktop computer, laptop or notebook computer, mainframe computer system, handheld computer, workstation, network computer, a consumer device, application server, storage device, a peripheral device such as a switch, modem, router, etc, or in general any type of computing device.

The animation-authoring environment described herein may be provided as a computer program product, or software, that may include a computer-readable storage medium having stored thereon instructions, which may be used to program a computer system (or other electronic devices) to perform a process according to various embodiments. A computer-readable storage medium may include any mechanism for storing information in a form (e.g., software, processing application) readable by a machine (e.g., a computer). The computer-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

A computer system 500 may include one or more processors 560, each of which may include multiple cores, any of which may be single or multi-threaded. The computer system 500 may also include one or more persistent storage devices 550 (e.g. optical storage, magnetic storage, hard drive, tape drive, solid state memory, etc), which may persistently store movie data 555, such as Flash source files, compiled Flash files, and/or others movie formats.

Computer system 500 may further comprise any number of I/O devices, such as 570. For example, I/O devices 570 may include one or more monitors 572 for displaying movies and/or an animation environment GUI, such as animation-authoring environment GUI 100 of FIG. 1. In the illustrated embodiment, I/O devices 570 may also include a keyboard 574, mouse 575, and/or other input components usable by an author to interact with the authoring environment GUI.

According to the illustrated embodiment, computer system 500 may include one or more memories 510 (e.g., one or more of cache, SRAM, DRAM, RDRAM, EDO RAM, DDR 10 RAM, SDRAM, Rambus RAM, EEPROM, etc.). The one or more processors 560, the storage device(s) 550, I/O devices 570, and the system memory 510 may be coupled to an interconnect 540. Various embodiments may include fewer or additional components not illustrated in FIG. 5 (e.g., video cards, audio cards, additional network interfaces, peripheral devices, a network interface such as an ATM interface, an Ethernet interface, a Frame Relay interface, etc.)

One or more of the system memories 510 may contain program instructions 520. Program instructions 520 may be encoded in platform native binary, any interpreted language such as Java™ byte-code, or in any other language such as C/C++, Java™, etc or in any combination thereof. Program instructions 520 may include program instructions executable to implement an animation-authoring environment 522 as described herein, such as animation-authoring environment 400. Program instructions 520 may also include instructions executable to implement shared libraries 524, such as shared physics libraries. In such embodiments, authoring environment 522 (or a component thereof, such as physics simulation engine 415) may utilize shared physics simulation libraries in shared libraries 524, to extrapolate motion paths as described herein. In some embodiments, program instructions 520 may also include program instructions executable to implement one or more operating systems 526, such as Windows™, MacOS™, Unix, Linux, etc.

The system memory 510 may further comprise movie data 530, such as animation frames drawn by an author or otherwise generated by animation-authoring environment 522. Movie data 530 may include various other movie data in source, intermediate, or target formats. For example, movie data 530 may include data describing frames defined in authoring environment 522, animation source data (e.g., Flash source), compiled animation data (e.g., .swf files), or other movie data that may not yet have been written to persistent storage 550.

Although the embodiments above have been described in considerable detail, numerous variations and modifications will become apparent to those skilled in the art once the above disclosure is fully appreciated. For example, various functionalities may be implemented in hardware rather than in software components. It is intended that the following claims encompass all such variations.

What is claimed:

1. A computer-readable storage medium storing program instructions executable by a computer processor to implement an animation-authoring environment comprising:
a graphical user interface usable to define an initial key frame, including a scene entity having: an initial location and one or more physics properties; and
a motion path extrapolation engine configured to calculate a motion path for the scene entity, wherein the motion path extrapolation engine utilizes a physics simulation to determine the motion path given at least an initial location of the scene entity and one or more physics properties of the scene entity; and
a frame generator configured to generate a sequence of frames, wherein each successive frame in the sequence depicts the scene entity at a successive location along the extrapolated motion path.

2. The computer-readable storage medium of claim 1, wherein the one or more physics properties includes a property of matter or a force acting on the scene entity.

3. The computer-readable storage medium of claim 1, wherein the one or more physics properties includes a global property applied to a plurality of scene entities in the initial key frame, including the initial entity.

4. The computer-readable storage medium of claim 1, wherein each frame in the sequence of frames is associated with a respective time according to a regular interval, and wherein each frame depicts the scene entity at a location of the motion path corresponding to the respective time.

5. The computer-readable storage medium of claim 1, wherein the animation-authoring environment further comprises a movie generator module configured to output a movie file comprising the sequence of frames.

6. The computer-readable storage medium of claim 5, wherein the movie file comprises a Flash movie file.

7. The computer-readable storage medium of claim 1, wherein the motion path is further dependent on a motion path of another scene entity.

8. The computer-readable storage medium of claim 1, wherein the motion path is independent of a motion path of another scene entity, wherein the respective motion paths of the first and second entity cross.

9. The computer-readable storage medium of claim 1, wherein the sequence of frames depicts another scene entity that is not associated with any physics properties.

10. A computer-implemented method for creating a frame-based animation, comprising:
displaying a graphical user interface of an animation-authoring environment;
receiving one or more inputs from the graphical user interface, the one or more inputs defining an initial frame, wherein the initial frame includes a scene entity, the scene entity having: an initial location and one or more physics properties; and
generating a sequence of extrapolated frames, said generating comprising:
using a physics simulation to extrapolate a motion path for the scene entity, the simulation being dependent at least on the initial location of the scene entity and on the one or more physics properties of the scene entity; and
configuring each successive frame in the sequence to depict the scene entity at a successive location along the extrapolated motion path.

11. The method of claim 10, wherein the one or more physics properties includes a property of matter or a force acting on the scene entity.

12. The method of claim 10, wherein the one or more physics properties includes a global property applied to a plurality of scene entities in the initial key frame, including the initial entity.

13. The method of claim 10, wherein each frame in the sequence of extrapolated frames is associated with a respective time according to a regular interval, and wherein each frame depicts the scene entity at a location of the motion path corresponding to the respective time.

14. The method of claim 10, further comprising: outputting a Flash movie file comprising the sequence of frames.

15. The method of claim 10, wherein the motion path is further dependent on a motion path of another scene entity.

16. The method of claim 10, wherein the sequence of frames depicts another scene entity that is not associated with any physics properties.

17. A computer system comprising:
a processor; and
a memory coupled to the processor and storing program instructions executable by the processor to implement an animation-authoring environment comprising:
a graphical user interface usable to define an initial key frame, including a scene entity having: an initial location and one or more physics properties; and
a motion path extrapolation engine configured to calculate a motion path for the scene entity, wherein the motion path extrapolation engine utilizes a physics simulation to determine the motion path given at least an initial location of the scene entity and one or more physics properties of the scene entity; and
a frame generator configured to generate a sequence of frames, wherein each successive frame in the sequence depicts the scene entity at a successive location along the extrapolated motion path.

18. The computer system of claim 17, wherein the one or more physics properties includes a global property applied to a plurality of scene entities in the initial key frame, including the initial entity.

19. The computer system of claim 17, wherein the motion path is further dependent on a motion path of another scene entity.

20. The computer system of claim 17, wherein the animation-authoring environment further comprises a movie generator module configured to output a Flash movie file comprising the sequence of frames.
